(19) United States
(12) Patent Application Publication
(10) Pub. No.: US 2015/0025939 A1
(43) Pub. Date: Jan. 22, 2015

(54) Company Centric Social Media Platfonn for Content Sharing aud Tracking

(71) Applicants: Somnath Chatterjee, Cupertino, CA (US); Krishnakumar Subramanian, Fremont, CA (US)

(72) Inventors: Somnath Chatterjee, Cupertino, CA (US); Krishnakumar Subramanian, Fremont, CA (US)

(21) Appl. No.: 13/945,456

(22) Filed: Jul. 18, 2013

(51) Int. Cl. G06Q 10/06; G06Q 50/00

(52) U.S. Cl. CPC G06Q 10/0637; G06Q 50/01
USPC 705/7.36

(57) ABSTRACT

Social networks by their nature are networks of people and their user-generated content. This content is usually un-curated and does not follow a general theme. This makes it very hard for people to find information they seek in these networks. When it comes to business centric communities, they need a better network where content is curated, tagged, and indexed properly thus making it easy for users to find the relevant content. SharePract is a community of curated, tagged, and indexed companies along with curated, tagged, and indexed content, making it easy for companies to find their business partners, clients, vendors, service providers, legal documents, marketing reports, business videos, webinars, and much more.

### BACKGROUND

This utility application claims priority based on the filing date of United States Provisional Patent Application 61673531 filed 2012 Jul. 19.

Companies worldwide have resorted to the internet to access knowledgebase and make new connections in the last fifteen years. But the internet is not easy to discover, nor is getting the needed resources to grow a company. Spending countless hours to find the right partners, right vendors, service providers, white papers, etc. is counterproductive to growing companies. This requires a social platform where one can find the necessary resources without wasting too much time.

Social media has in the past few years opened up many avenues for people and companies to share information. It is all too easy for people to upload videos, white papers, PDFs. But with the current state of social media there is more information that one can really handle. Today's social media is full of un-curated and un-categorized content. So it becomes the burden of the user to search and find relevant content. What we need is a specialized social media for specific content. Content that is categorized and curated for users to make it easy for users to consume.

A resources-matching platform can take the needs from companies and find the matching service providers and resources. This mechanism requires a thorough process of categorizing all content and companies with a SharePract activity index.

SharePract is the only company centric social media platform allowing inter-company linkages and exchanges. Also serves as a “one-stop shop” for companies among small businesses to access resources, learning tools, services, hot deals through e-commerce, and global connectivity. This company centric approach makes it easy for other companies and service providers to build durable relationships and track their progress. Such company level interactions using social media are, therefore, extremely valuable but currently not available. SharePract offers tools, techniques, business logic for queries, searches, and analytics for all of its member companies of this social media platform.

SharePract is based on social interactions between its members. Members are allowed to interact with the system and also with other users, thus building communities, building common ideologies, exchanging notes, best practices, making connections, etc. This set of interactions can be thought of as mimicking real-life interactions.

Social aspects of the site (Likes, Dislikes, and Flags) are exchanged behind the scenes between different pages of the system. When a certain page takes an input it goes through all the different layers of the SharePract system down to the database layer and resurfaces on some on a different page, navigated by a totally different user. The same is true with Connections, Status Updates, and Direct Messages.

SharePract offers a unique method of making connections. Connections that are beyond a single user and tied to entities. Connections that cannot be transferred to other companies as users move from one company to another. In SharePract, connections are made between companies and not users. This allows a company's connections to grow over time and never diminish in value as important people in the company leave. This also allows companies to maintain relationships even after the connector leaves the company. In all other social sites, people are the center of social interactions. This approach has been improved upon and a company centric approach has been adopted by SharePract.

In accordance to this invention there is provided a social platform that enables companies to discover other companies who match their needs, in order to form new alliances and partnerships. Along with finding companies the platform also provides mechanism to share their resources and best practices with other companies to allow other companies to leverage the knowledgebase of other companies.

### BRIEF DESCRIPTION OF THE DRAWINGS

The following figures represent examples and not the invention itself.

FIG. 1 is a diagram of a relationship between a Company AA with a Company BB.

FIG. 2 is a diagram of a process to send and receive information from a Company A to a Company B.

FIG. 3 is a flowchart of a process for Login and Signup.

FIG. 4 is a flowchart of a user validation process.

FIG. 5 is a flowchart of a process for sharing resources between User A from Company A and User B from Company A.

FIG. 6 is a flowchart of a process for interacting with the platform between Login and Logout.

FIG. 7 is a screenshot of HomePage.

FIG. 8 is a screenshot showing company centric profiling in SharePract website.

FIG. 9 is a screenshot of Sharing Tools.

FIG. 10 is a screenshot of Company feeds, Share, and Likes.

FIG. 11 is a screenshot of content generation through Learning Kit.

FIG. 12 is a screenshot of Mentoring features and tools.

FIG. 13 is a screenshot showing how content is tracked.

FIG. 14 is a screenshot of content matching by companies' needs.

### DETAILED DESCRIPTION

The SharePract system will be a web-based solution hosted in the cloud (Azure), meaning it has 24/7 global availability and also can scale up processing of incoming requests as demand increases. Azure is a platform as a service (PAAS) and Microsoft's cloud solution for building and deploying massively scalable solutions across the global network. Database, Storage, CDNs, Application Instances, etc. can be deployed incrementally and as the SharePract community grows one can fine-tune the increments. Any conventional web browser (IE, Safari, Chrome, FireFox, etc.) can access the SharePract system by going to the URL www.SharePract.com). Upon hitting the URL the SharePract system will serve web pages (HTML pages) that get rendered on the client browser. Multiple people can access the SharePract system at the same time. Each person's browsing state is maintained separately in the SharePract system.

In the SharePract architecture, the web servers access the business logic layer, which in turn accesses the data logic layer, which in turn connects to the database to retrieve data from the backend. There can be multiple web servers that can be deployed to allow an increasing number of people to access the SharePract system. Multiple databases can be deployed to hold user data in shards. This allows flexible scaling of the system as the site grows in demand and the number of hits increase.

User information is stored in database systems by using entity relationships (i.e. a user's basic information goes into one table while a user's company information goes into another table with a relationship link between the two tables). This form of data storage allows logical grouping of data into its own datasets. It also allows minimal modifications of the database in case one of the datasets need to be modified.

Web pages in SharePract are navigated based on a user's selection to pages. If the user is not logged into the system, only public pages (i.e. home page, contact page, about us page, and in future company profile pages) can be navigated to. All other pages will require the user to log into the system. Once the user is logged in the user can decide to click on any link and will be taken to that page. There is no enforced sequence of pages, unless certain business logic prohibits out of order page navigation. When such business logic prohibits out of order navigation the user will be assisted with user friendly messages thus helping them navigate in order.

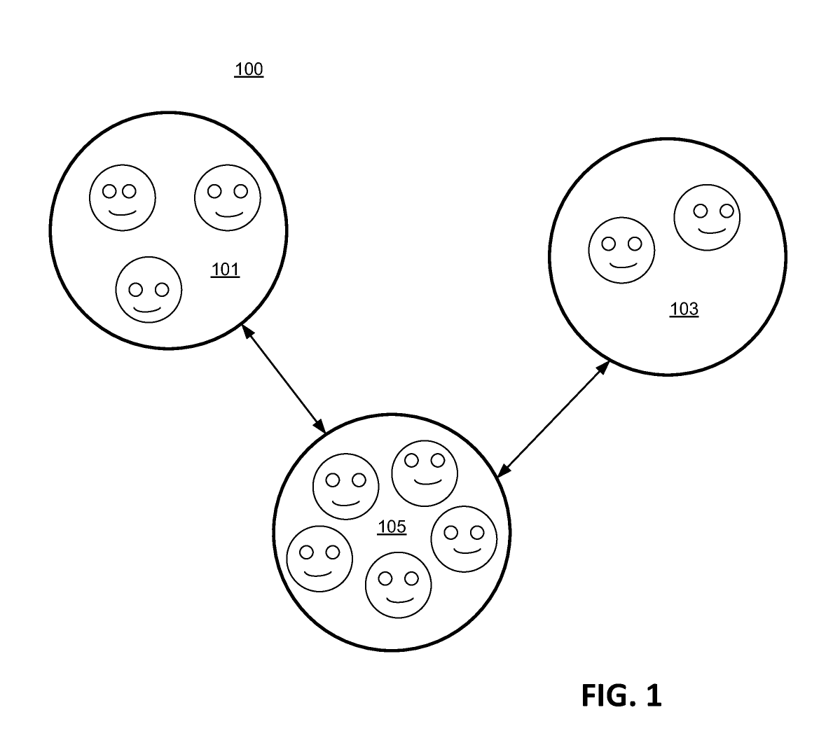

FIG. 1 is a diagram of company account relationships 100 with other companies. Users from Company A 101 are able to engage in intra-company exchange with other users from Company A. Users from Company B 103 are able to engage in intra-company exchange with other users from Company B. Company A and Company B are able to engage in inter-company exchange allowing users 101 and users 103 from their respective companies to connect with each other. However, individual users from separate companies are unable to form a relationship outside of the bounds of the relationships of their respective companies.

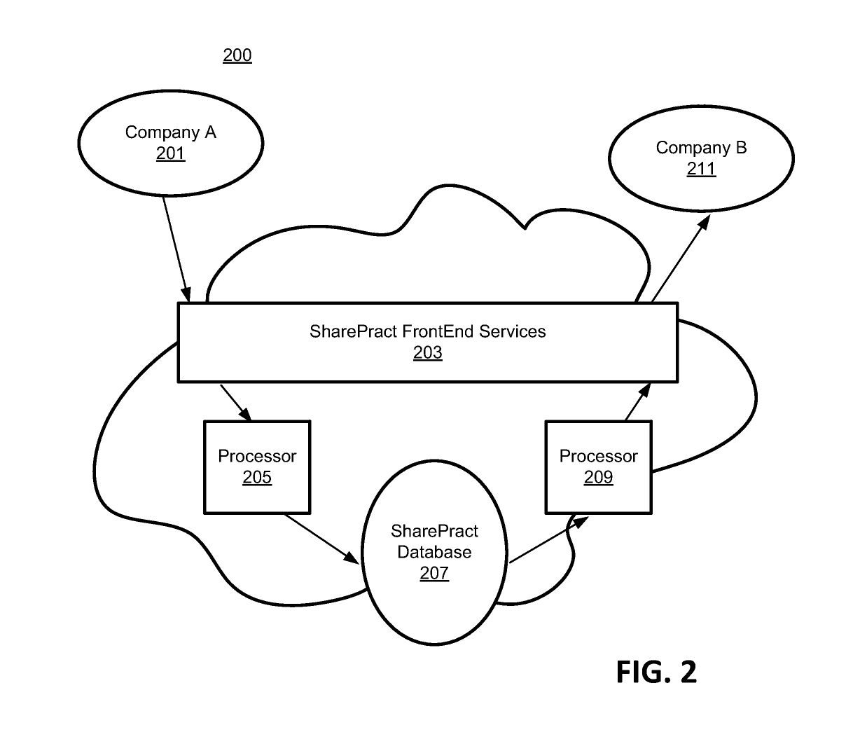

FIG. 2 depicts a model 200 for interaction between a Company A 201 and Company B 211. Company A 201 has access to SharePract FrontEnd Services 203 that provides information and an ability to interact with said Company B 211. The SharePract FrontEnd Services 203 are powered by a processor 205 on the end of Company A communicating with a processor 209 on the end of Company B via the SharePract Database 207.

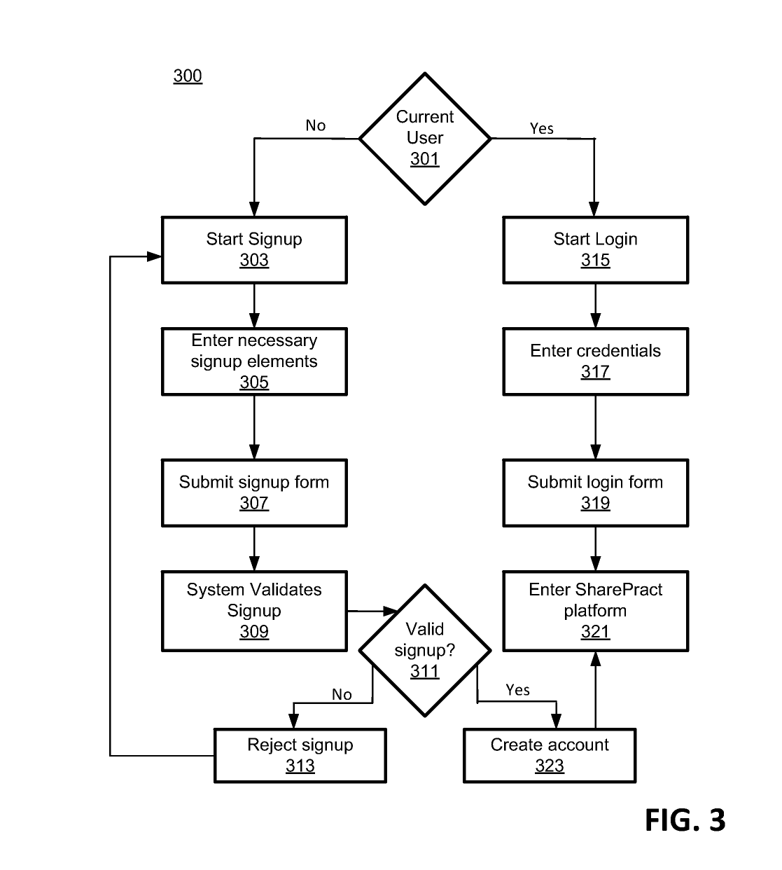

FIG. 3 depicts a method for entering the system 300 either for the first time or as a returning user. The user enters the site and decides whether they are a returning user or a new user at 301. In the instance of a new user a signup process begins at 303. The user then enters necessary signup elements at 305 and submits their signup form at 307. The system then attempts to validate this signup information at 309 and determines the signup validity at 311. If the validation is unsuccessful the signup process is rejected at 313 and the user is returned to signup step 303. If the system validates the signup a new account is created at step 323 and the user can enter the platform at 321. If the user is a returning user, they go to login at step 315. After entering their credentials at 317, the user submits the login form at 319 and gains access to the platform at 321. This user identity is carried over throughout the active session the user has in the site.

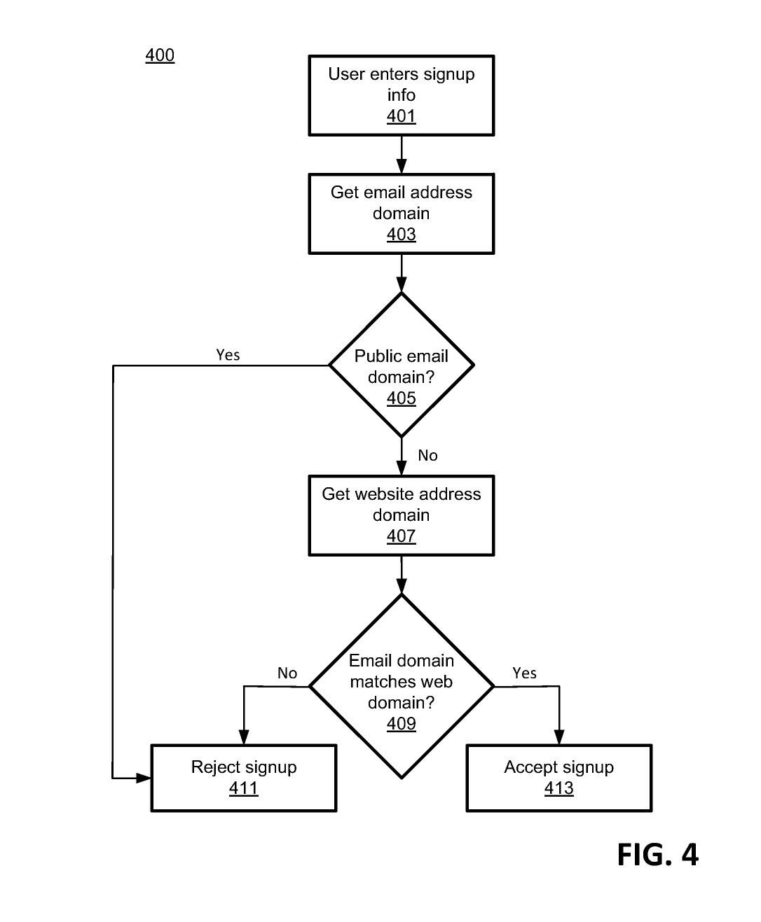

FIG. 4 depicts a method 400 for prospective user signup to the SharePract platform. Users enter their signup information at 401 and enter their email address domain at 403. At method step 405, the email address entered at 403 is checked to determine whether or not said email address is of a public email domain. If so, the signup attempt is rejected at 411. If said email address is not of a public domain then access to the website is granted at 407. Another check is performed at 409 to determine whether the email domain matches the web domain. If not, the signup attempt is rejected at 411. If the domain matches a web domain the signup is accepted at 413.

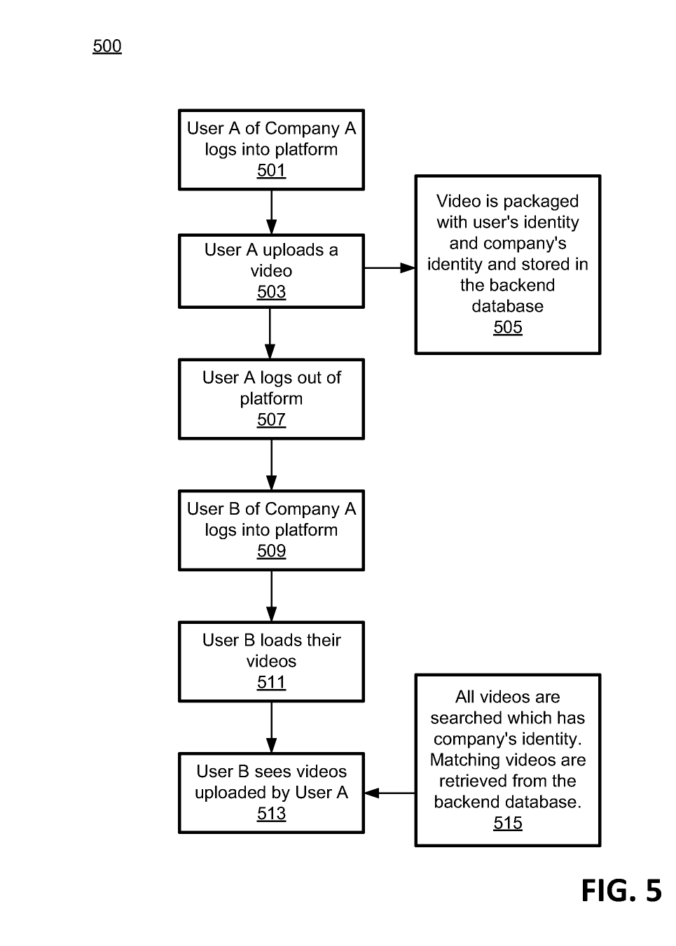

FIG. 5 depicts a method 500 for viewing videos uploaded by other users. The process starts at with a User A of Company A logging into the platform at 501. User A uploads a video 503 so that the video is packaged with the user's and company's identity and stored in the backend database at 505 and then User A logs out of the platform 504. User B of Company A logs into the platform at 509 and loads their own videos at 511. At 513 User B sees videos uploaded by User A and matching videos are retrieved from the backend database at 515.

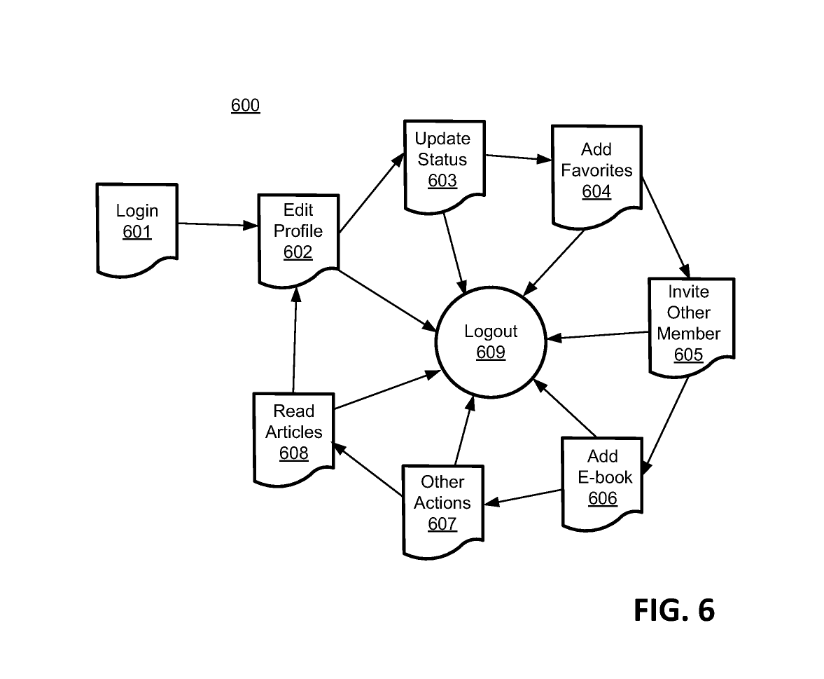

FIG. 6 details a flow diagram The users can logout from the system from any page if they wish to do so. A user can take one action or many actions before logging out of the system. FIG. 6 depicts method 600 detailing a user's actions 602-609 on the site and how they can logout 611 after performing a number N of actions.

Login 601 and Logout 611 are two important functions of the system that ensures that a user's private information is not accessed by someone else. The user's intent to Login is constituted as an acceptance of their identity in the SharePract system. Once logged in, the user's identity is maintained in the entire session. A session is defined as a period of time between a login and a logout. On logout, the session is ended and the user is no longer authenticated to access any private pages.

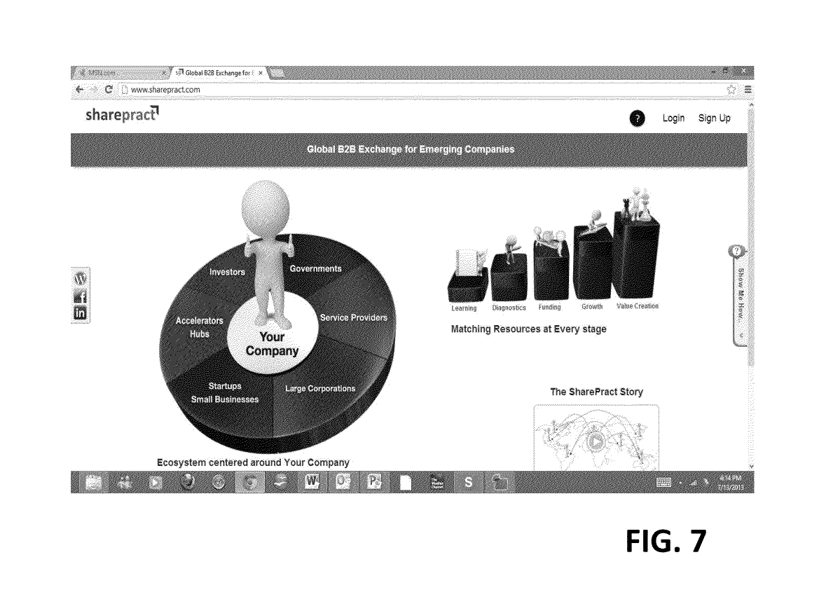

FIG. 7 depicts a screenshot of the SharePract HomePage, capturing Online Ecosystem for matching resources at every stage of company growth and the ecosystem players. This is the first visible page when a user visits the SharePract website prior to logging in.

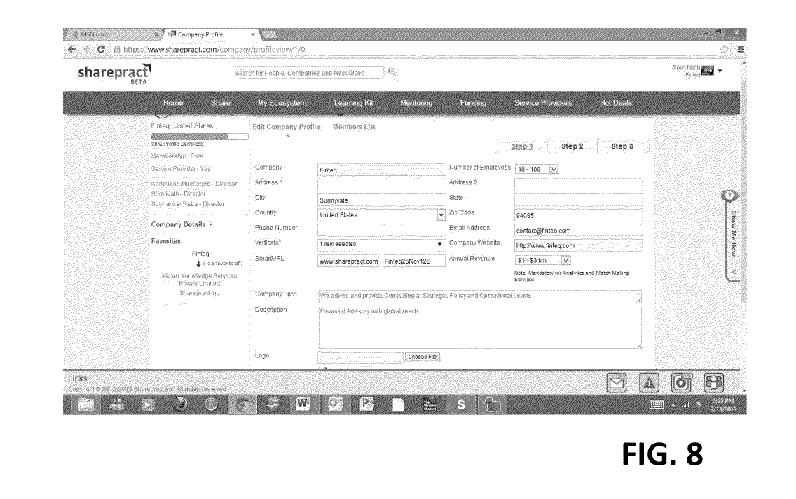

FIG. 8 depicts a screenshot showing the company-centric profiling in the SharePract website. This shows the first step when a user creates a company profile page. This includes information such as the company name, company contact information, and the company's website.

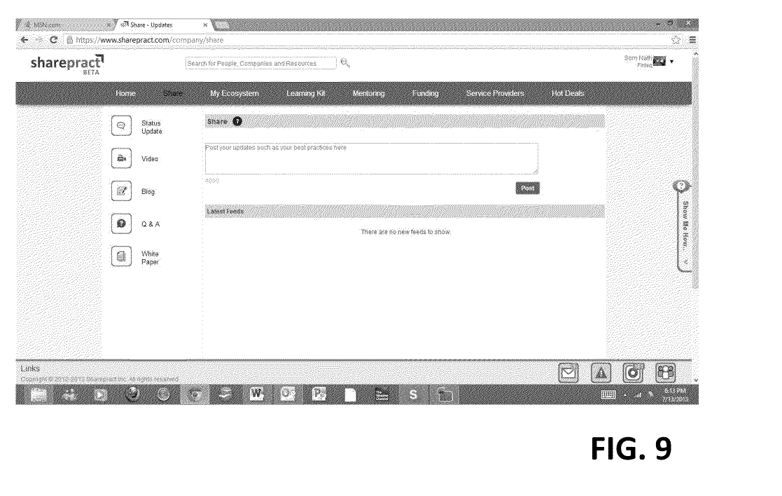

FIG. 9 depicts a screenshot of Sharing Tools comprising status update, video, blog, Q&A, and White Paper.

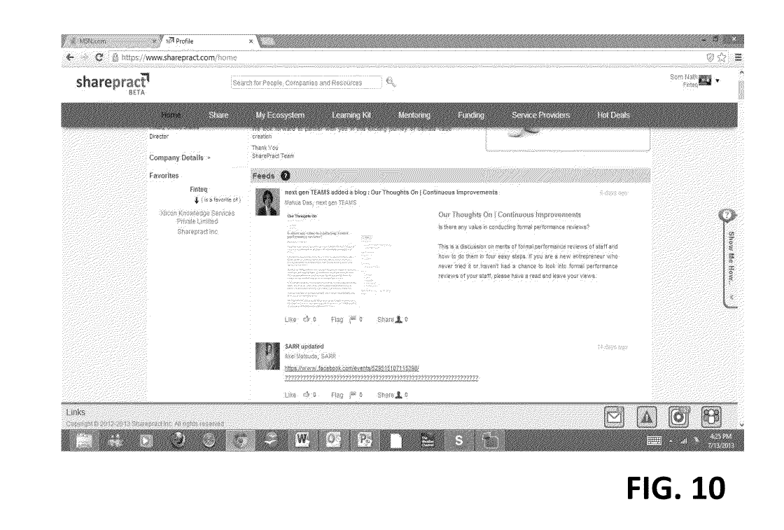

FIG. 10 depicts a screenshot of company feeds, Shares, and Likes. The newsfeed includes important updates from connected companies. The number of Shares and Likes each post receives is indicated at the bottom of the post.

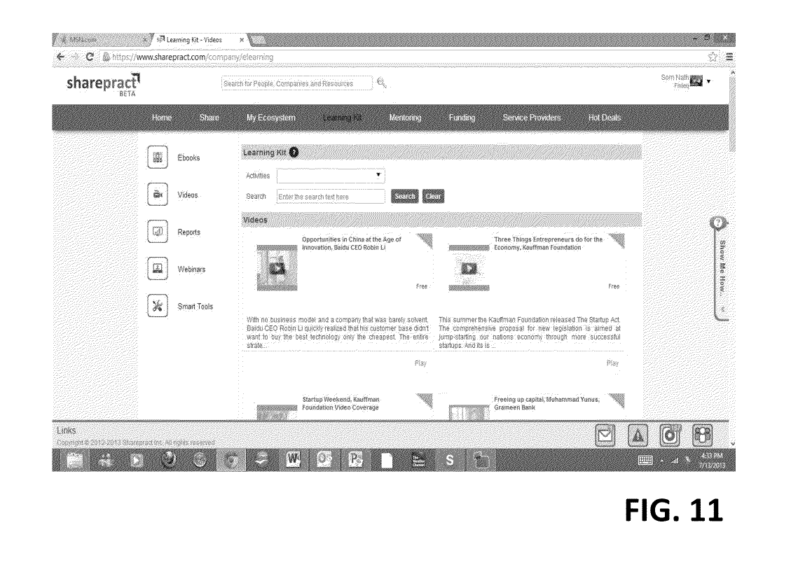

FIG. 11 is a screenshot of content generation through the Learning Kit comprising of E-Books, Videos, Reports, Webinars, and Smart Tools. Users may access learning materials in the Learning Kit tab.

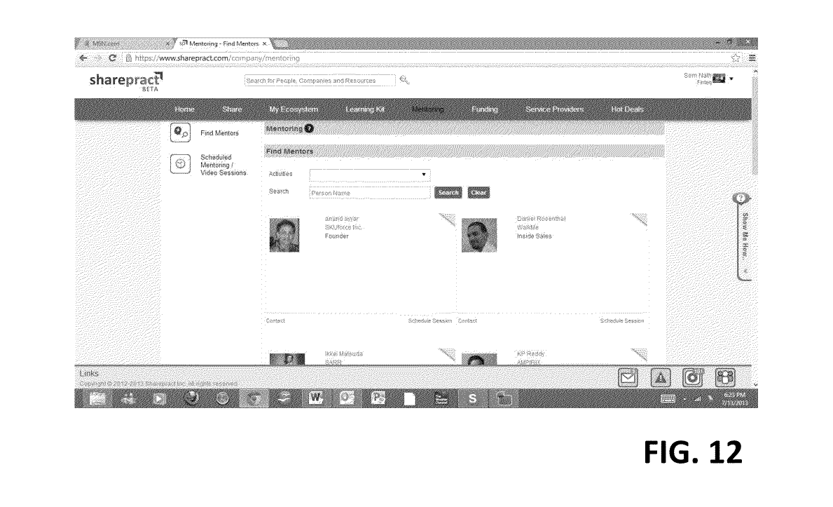

FIG. 12 depicts a screenshot of Mentoring features and tools used to find mentors and schedule mentoring sessions.

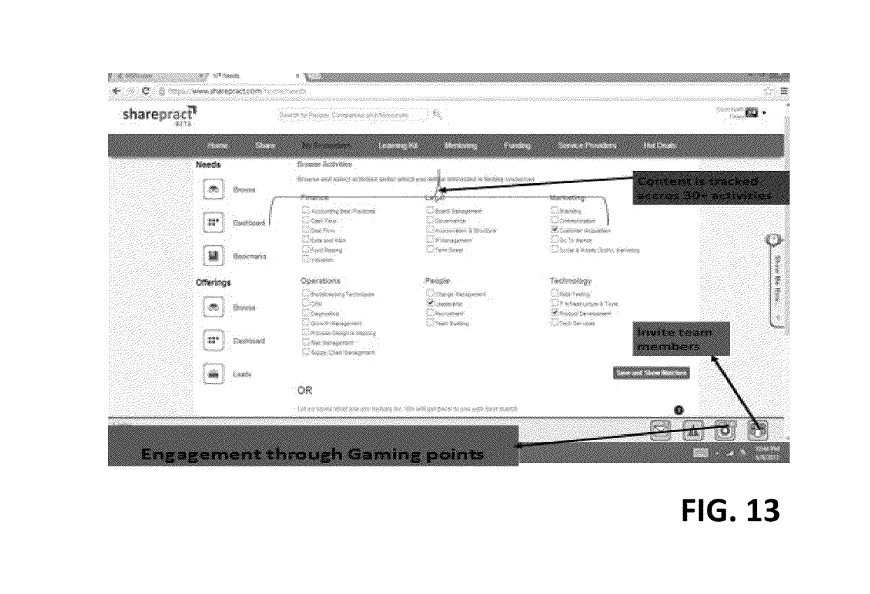

FIG. 13 is a screenshot of how content is tracked across more than 30 activities under six heads of Marketing, Finance, Technology, Operations, People, and Legal.

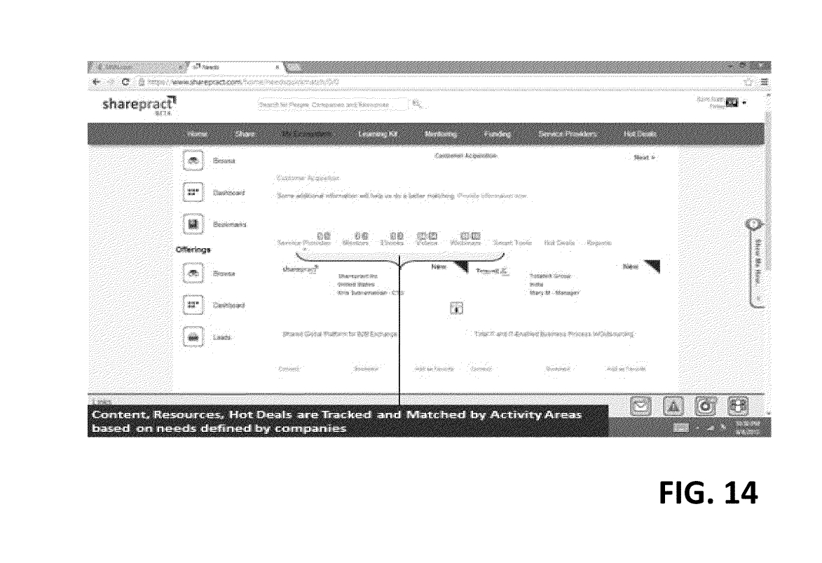

FIG. 14 is a screenshot showing how content is matched by companies' needs across 30 or more activities.

Every company can make connections in the SharePract system. Connections are the basis of user-generated networks. Connections can be defined as upstream and downstream connections. Upstream connections are connections that are created by a company to follow other companies. Downstream connections are connections that are created by other companies to follow a company. Connections also define how information flows in the SharePract system.

Status updates are simple ways to socialize with other companies. A status update is received by all of the companies that have downstream connections. A status update is a small snippet of information that summarizes a company's daily or weekly highlight(s). This is a broadcast mechanism which is an effective tool for marketing and evangelizing about a company.

Direct messages are another form of communication available to users to create a network and exchange information with other companies and its members. These are private messages between two specific parties.

When a company likes a particular entity in the system the number of likes for that entity increases by one, thus making the entity more popular than other similar items. This crowd-based voting is a user-generated content that pushes popular items to the top and less popular items below.

SharePract's community members, who are companies, start acquiring points through account creation, logins, data, and offerings in their profile. This point system continues with sharing of content in terms of updates, Question and Answer, Videos, and White Papers. The next round of the point system starts with more advanced features like Smart Tools, Learning Kits, and Mentoring and gets reflected in Journey. This kind of content generation is encouraged by the mapping of companies and introduction of gamification by awarding points for such activities.

Smart Tools: Smart Tools as the name suggests are smart and easy ways for companies to do a self-appraisal. Regularly appraising themselves companies can see how their company's journey is taking shape.

Mentoring: As companies grow, they need mentors at every stage. SharePract offers a facility to search and schedule appointments with Mentors with whom one can communicate via Video conferencing from the ease of their desktops and laptops. This method of connecting mentors with mentee across the globe makes it easy for companies to find the right mentor from the right region to solve their business problems.

Gamification: The SharePract platform is a gamified platform. What this means is users of the platform are essentially playing a game every day they access SharePract. Certain activities of the user are tracked and points are awarded to the companies of the user. Then these points are accumulated to award badges. These badges are then used to access certain restricted resources that can only be accessed by companies that have the required set of badges. This cycle of translating user's activity into keys for opening gates to access resources is the gamification aspect of SharePract.

In summary, users gain points for all activities beginning from creating an account and logging in to profile updating and sharing. Later on, points are earned for Smart Tools, learning centers, service providers, and hot deals. In phase, integration of the point system and Journey, as well as the E-Commerce system of SharePract, would be required. The Journey section provides the caricature of each user in terms of where it stands in terms of its points with a snapshot sketched out; it could inter alia be the staircase of learning.

Hot Deals: All companies need a break and some discounted stuff always goes a long way. Hot Deals is a section that allows companies to make their offerings with discounted prices to allow the SharePract community to grab the deals while they last.

Verticals: Companies can map themselves into different Verticals they belong to. This mapping forms the basis for SharePract to understand what the company does and what it can offer to SharePract. Inherent groups are formed around these Verticals that can readily share information with each other.

Favorites: Companies can go out of the above inherent group (Verticals) and start making new connections with other unknown companies. This enables companies to follow what other companies of interest are doing. The relationship is not bi-directional by default, i.e. if company A becomes a favorite of company B then company B does not become a favorite of company A. This is the default nature of this relationship. When company A is following company B all the public information company B shares in SharePract systems automatically is shown in company A's feed.

Feed: SharePract collects information from the SharePract eco-system and displays the information in everyone's default page as a continuous stream chronological information. This is the SharePract feed. The feed essentially saves time by pulling information rather than having each company search for information that others share.

However, things could get more sophisticated and analytical as the point system graduates to more advanced levels. This happens through:
1. Consumption of Smart Tools and Learning Kit in relation to SharePract50 Index,
2. Scores achieved through Smart Tools,
3. Participation through Mentoring with points available to both Mentors and Mentees,
4. Points for buying services from SharePract preferred sellers, and
5. Points from group strategy and collaborative games—possibly among special interest groups (SIGs)-Birds of Same Feather.

Activities: SharePract has come up with a set of activities. These activities are core to the SharePract offering. These activities define company's needs, company's offerings, resource offerings and mentor offerings. Using these needs and offerings SharePract performs matchmaking services (defined later).

These activities show up in the Journey area of the user page and make it possible for other companies, investors, incubators or for that matter, anyone interested in doing business with this company based on its activity/accomplishment level. The Journey tab allows companies to showcase themselves across multiple activity levels, performance targets, and as prominent brands.

SharePract to employ a “freemium” model with paid and free services for its company members. The following aspects are relevant to understand how this company centric platform operates with E-Commerce integration and the logic behind this exercise is presented in this section.

The payment scheme for companies for membership in general and also that for content as well as other transactions, shall be guided by the SharePract E-Commerce integration strategy and its objectives for user-friendly consumption and distribution of SharePract content and services.

In this specification, related art is discussed for expository purposes. Related art labeled “prior art”, if any, is admitted prior art. Related art not labeled “prior art” is not admitted prior art. In the claims, “said” introduces elements for which there is explicit verbatim antecedent basis; “the” introduces elements for which the antecedent basis may be implicit. The illustrated and other described embodiments, as well as modifications thereto and variations thereupon are within the scope of the following claims.

What is claimed is:

1. A company centric social media platform comprising:
diagnostic tools that identify a company's business emergence stage.

2. A company centric social media platform as in claim 1 further comprising a resource mapping utility for matching available business development resources with the needs of a company based on said business emergence stage.

3. A company centric social media platform as in claim 1 wherein plural companies are connected based on at least one of said companies' emergent stages.

4. A company centric social media platform as in claim 1 wherein an account manager, not representing an individual, manages the business' account.
